(19) United States
(12) Patent Application Publication
(10) Pub. No.: US 2016/0333166 A1
(43) Pub. Date: Nov. 17, 2016

(54) COLORABLE MOLDING COMPOUND HAVING ALKALIZING PROPERTIES AND DEVICE FOR GENERATING ALKALINE REDUCED WATER MOLDED USING THE SAME

(71) Applicants: Ki Chun PARK, Incheon (KR); AEON KOREA CO., LTD, Incheon (KR)

(72) Inventor: Ki Chun PARK, Incheon (KR)

(21) Appl. No.: 14/737,624

(22) Filed: Jun. 12, 2015

(30) Foreign Application Priority Data
May 12, 2015 (KR) 2015-0066049

(51) Int. Cl. C08K 3/08; A47G 19/22; A47K 3/02; B65D 85/72; B65D 85/52

(52) U.S. Cl. CPC C08K 3/08; B65D 85/72; B65D 85/52; A47K 3/02; A47G 19/2205

(57) ABSTRACT

This invention relates to a colorable molding compound, which can be imparted with a predetermined color, and to a device for generating alkaline reduced water molded using the same, wherein alkaline reduced water can be generated without the use of separate means for producing alkaline reduced water. When water is placed in a product obtained by mixing 50-90 parts by weight of a synthetic resin, 2-30 parts by weight of magnesium, and 2-30 parts by weight of potassium; grinding the mixture to a size of 20 meshes; drying the ground mixture in an oven at 80-90 C for 2 hr; compounding the dried mixture at a high speed for 5-30 min using a compounding machine; and then performing extrusion molding, alkaline reduced water can be generated by magnesium and potassium.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates to a colorable molding compound having alkalizing properties and a device for generating alkaline reduced water molded using the same. More particularly, the present invention relates to a colorable molding compound, which may be imparted with a predetermined color and has anew composition suitable for molding a product that is able to generate alkaline reduced water, without the use of separate means for producing alkaline reduced water, and a device for generating alkaline reduced water molded using the same.

2. Description of Related Art Including Information Disclosed Under 37 CFR 1.97 and 37 CFR 1.98

Alkaline reduced water can be quickly absorbed in vivo and thus exhibits outstanding thirst quenching effects, and is effective at alkalizing an acidified body to thereby improve physical functions and also at removing active oxygen known as the primary cause of aging. Furthermore, alkaline reduced water may function to prevent adult diseases and to promote the discharge of the body waste, and may alleviate symptoms such as chronic diarrhea, indigestion, hypergastric acidity and the like. Moreover, alkaline reduced water possesses a variety of efficacies beneficial to the human body, such as treating atopic dermatitis and preventing skin diseases.

Such alkaline reduced water is produced via electrolysis or using a mineral such as magnesium. Although electrolysis is carried out using an expensive electrolyzer, the use of a mineral is advantageous because adding a mineral having an ionization tendency greater than hydrogen to water is merely performed, thus cheaply producing alkaline reduced water.

Meanwhile, a mineral for producing alkaline reduced water is molded in the form of a stick, or is provided in the form of a capsule configured such that the mineral is molded into a ball that is then embedded in a case. Unless such a mineral stick or mineral capsule is hygienically managed, it may cause the growth of bacteria. Hence, the mineral stick or mineral capsule has to be cleanly washed before use, and should be hygienically stored when it is not used, thus it is complicated and requires considerable attention. In particular, the mineral capsule has to be washed so that the inside of the case is not covered with slime. Also, the case has to be separated to wash the mineral and the inside of the case, undesirably incurring cumbersome management. When the mineral stick or capsule is not used, it should be separately stored. In some occasions, such a stick or capsule may be lost. Useful for the mineral stick or capsule is a molding compound composed of an inorganic material and a synthetic resin; however, despite attempts at providing such a molding compound in diverse colors, many difficulties remain in preparing such a compound.

### CITATION LIST

### Patent Literature

Patent Document 1: Korean Patent No. 10-0964560 (Jun. 10, 2010)

Patent Document 2: Korean Patent No. 10-1393158 (Apr. 30, 2014)

### BRIEF SUMMARY OF THE INVENTION

Accordingly, the present invention has been made keeping in mind the above problems encountered in the related art. Korean Patent No. 10-1393158 by the present applicant discloses a molding compound having alkalizing properties and a device for generating alkaline reduced water molded using the same, wherein even when water is simply placed in the device for generating alkaline reduced water, alkaline reduced water maybe generated by a mineral loaded in such a device, thus enabling the convenient use of the device for generating alkaline reduced water and the hygienic management thereof and producing mineral-rich alkaline reduced water, and thus an object of the present invention is to provide a colorable molding compound, which may result from imparting the above molding compound with a color, and a device for generating alkaline reduced water molded using the same.

The present invention provides a colorable molding compound having alkalizing properties, suitable for use in molding a colorable product able to hold water, which is obtained by mixing 50-90 parts by weight of a synthetic resin, 2-30 parts by weight of magnesium, and 2-30 parts by weight of potassium; grinding the mixture to a size of about 20 meshes; drying the ground mixture in an oven at 80-90 C for 2 hr; and compounding the dried mixture, wherein alkaline reduced water is generated by magnesium and potassium when water is placed in the molded product.

In addition, the present invention provides a colorable device for generating alkaline reduced water, molded using the colorable molding compound obtained by mixing 50-90 parts by weight of a synthetic resin, 2-30 parts by weight of magnesium, and 2-30 parts by weight of potassium; grinding the mixture to a size of about 20 meshes; drying the ground mixture in an oven at 80-90 C for 2 hr; and compounding the dried mixture, wherein alkaline reduced water is generated by magnesium and potassium when water is placed in the device for generating alkaline reduced water.

In addition, the present invention provides a colorable device for generating alkaline reduced water, comprising the colorable molding compound obtained by mixing 50-90 parts by weight of a synthetic resin, 2-30 parts by weight of magnesium, and 2-30 parts by weight of potassium, based on the compound; grinding the mixture to a size of about 20 meshes; drying the ground mixture in an oven at 80-90 C for 2 hr; and compounding the dried mixture.

According to the present invention, a colorable molding compound contains magnesium and potassium for producing alkaline water when coming into contact with water. Thus, when water is simply placed in a product molded using such a compound, alkaline reduced water can be produced by magnesium and potassium loaded in the product, thereby readily ensuring alkaline reduced water without the use of separate means for generating alkaline reduced water such as conventional mineral sticks or mineral capsules.

The use of such a product is convenient because water is merely placed in the product, and there is no concern of polluting water due to poor management of conventional mineral sticks or mineral capsules. Furthermore, alkaline reduced water can have high mineral content by virtue of mineral components loaded in the device for generating alkaline reduced water, thereby making it easy for a user to drink mineral-rich alkaline reduced water.

Although a conventional molding compound including an inorganic material is difficult to exhibit a coloring effect via mixing of feeds, a colorable molding compound according to the present invention can be provided by use of additional processing so as to enable color blending. The colorable molding compound can be applied to colorful devices for generating alkaline reduced water (bottles) and other products, especially container products able to hold water, such as cups, bowls, Kimchi containers, flowerpots, water jugs, bathtubs, and wash basins. When the present invention is applied to a bathtub, water is placed in such a bathtub and thereby can be converted into alkaline reduced water, thus facilitating bathing or showering using alkaline reduced water. Since alkaline reduced water helps in the treatment of skin diseases such as atopic dermatitis, it can be produced anytime at home and can thus be beneficially utilized to treat a skin disease via bathing. Also, when the present invention is applied to a Kimchi container, the oxidation of Kimchi can be delayed, and thus Kimchi is not quickly spoiled. Also, when the present invention is applied to a flowerpot or a water jug, the growth of plants can be promoted.

### BRIEF DESCRIPTION OF THE SEVERAL VIEWS OF THE DRAWINGS

The above and other objects, features and advantages of the present invention will be more clearly understood from the following detailed description taken in conjunction with the accompanying drawings, in which:

FIG. 1 illustrates a process of preparing a colorable molding compound according to the present invention; and

FIG. 2 is a cross-sectional view illustrating a device for generating alkaline reduced water according to an embodiment of the present invention.

### DETAILED DESCRIPTION OF THE INVENTION

Hereinafter, a detailed description will be given of preferred embodiments of the present invention regarding a colorable molding compound having alkalizing properties.

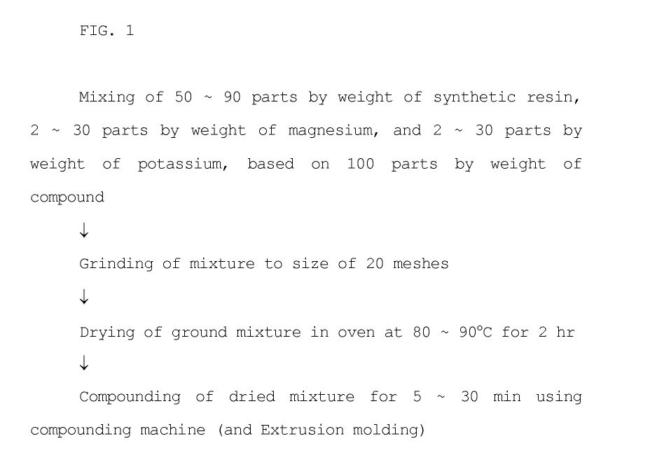

With reference to FIG. 1, a process of preparing a colorable molding compound according to an embodiment of the present invention is as follows.
(1) Based on 100 parts by weight of the compound, 50-90 parts by weight of a synthetic resin, 2-30 parts by weight of magnesium, and 2-30 parts by weight of potassium are mixed.
(2) The mixture comprising the synthetic resin, magnesium, and potassium is ground to a size of about 20 meshes.
(3) As ground to a size of about 20 meshes, the mixture comprising 50-90 parts by weight of the synthetic resin, 2-30 parts by weight of magnesium, and 2-30 parts by weight of potassium is dried in an oven at 80-90 C for 2 hr.
(4) The mixture is compounded at a high speed for 5-30 min using a compounding machine, resulting in a colorable molding compound.

In the colorable molding compound according to the present invention, an optimal compound particle size is set, and also, the drying process is preferably carried out using an oven at 80-90 C for 2 hr.

In the compound according to the present invention, the synthetic resin is preferably exemplified by polyethylene. When the synthetic resin partially contains a biodegradable resin, biodegradability is imparted to a molded container, thereby manufacturing an eco-friendly product. Also, the biodegradable resin, which is partially contained in the synthetic resin, may include, for example, polylactic acid (PLA). The PLA resin is a thermoplastic resin of lactide or lactic acid, and the discharge of an eco-unfriendly material generated in the course of use or disposal of the above resin is much lower than that of other resins, and also this resin is biodegradable and is thus eco-friendly.

Magnesium and potassium are mixed in a powder phase. Since potassium vigorously reacts with water, the use of potassium enables the quick production of alkaline reduced water, compared to when only magnesium is used. Preferably, the compound according to the present invention includes zeolite, white clay, and an additive such as a defoaming agent or a plasticizer in a small amount, in addition to the above components. Specifically, the compound is composed of 50-90 parts by weight of the synthetic resin, 2-30 parts by weight of magnesium, 2-30 parts by weight of potassium, 2-10 parts by weight of zeolite, 2-10 parts by weight of white clay, and a small amount of an additive. As such, zeolite has a function of purifying water, and white clay is responsible for enhancing sterilization performance.

Drinking water has a pH of about 7.7-9.5. In the present invention, the amounts of magnesium and potassium are controlled so as to produce alkaline reduced water at a pH of 7.7-9.5 when water is placed in a product molded using the compound of the invention. If the amounts of magnesium and potassium are less than the lower limit, the rate of production of alkaline reduced water may decrease, and thus water has to be placed for a long period of time in the product to generate alkaline reduced water having a desired pH value. Hence, taking into consideration the rate of production of alkaline reduced water and moldability, the amounts of magnesium, potassium and resin are controlled to the above levels.

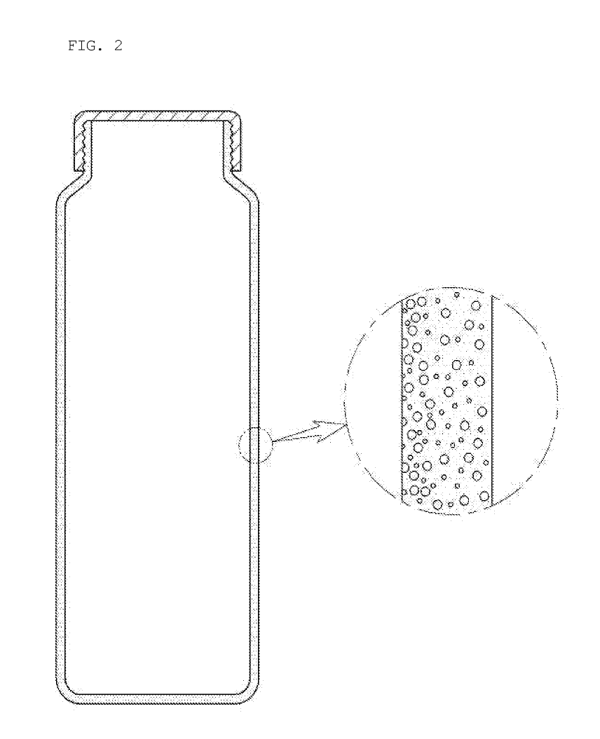

Such a colorable molding compound may be used to mold a variety of products. FIG. 2 illustrates a colorable device for generating alkaline reduced water manufactured in bottle form using the compound of the present invention. When such a colorable device for generating alkaline reduced water, that is, a bottle, is filled with water, magnesium and potassium loaded in the bottle come into contact with water, so that water is converted into alkaline reduced water. In this procedure, such mineral components are dissolved as ionic forms in water, thus increasing the mineral content of water. As necessary, the outer surface of the bottle may be subjected to a transfer process to form a pattern or mark.

Although the bottle is illustrated as above, the present invention maybe applied to all products in container form able to hold water. Specifically, the present invention may be applied to tableware such as cups or bowls, food storage containers such as Kimchi containers, toiletries such as bathtubs or wash basins, water baths for foot spas, and plant-related products such as flowerpots or water jugs. Depending on the shape of molded products, an appropriate molding process such as injection molding or blow molding may be adopted.

When using a bathtub molded from the compound of the invention, bathing may be carried out anytime at home using alkaline reduced water, and thus a great help may be given to the treatment of skin diseases such as atopic dermatitis. Since the delay of oxidation or the growth of plants may be promoted by alkaline reduced water, the use of a Kimchi container molded from the compound may delay the oxidation of Kimchi to thereby prevent Kimchi from being quickly spoiled. Furthermore, the use of a flowerpot or water jug molded from the compound enables alkaline reduced water to be supplied to plants to thus promote the growth of plants.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

I claim:

1. A colorable molding compound having alkalizing properties, suitable for use in molding a product able to hold water, which is obtained by:
mixing 50-90 parts by weight of a synthetic resin, 2-30 parts by weight of magnesium, and 2-30 parts by weight of potassium, based on 100 parts by weight of the compound;
grinding the mixture to a size of 20 meshes;
drying the ground mixture in an oven at 80-90 C for 2 hr; and
compounding the dried mixture at a high speed for 5-30 min using a compounding machine.

2. A device for generating alkaline reduced water, obtained by:
grinding a mixture comprising a synthetic resin, magnesium, and potassium to a size of 20 meshes;
drying the ground mixture in an oven at 80-90 C for 2 hr;
compounding the dried mixture at a high speed for 5-30 min using a compounding machine; and
performing molding,
wherein alkaline reduced water is generated by magnesium and potassium when water is placed in the device for generating alkaline reduced water.

3. The device for generating alkaline reduced water of claim 2, which is obtained by:
mixing 50-90 parts by weight of the synthetic resin, 2-30 parts by weight of magnesium, and 2-30 parts by weight of potassium, based on 100 parts by weight of the compound;
grinding the mixture to a size of 20 meshes;
drying the ground mixture in an oven at 80-90 C for 2 hr;
compounding the dried mixture at a high speed for 5-30 min using a compounding machine; and
performing extrusion molding.

4. A colorable molded product having alkalizing properties with a container shape, which is obtained by:
grinding a mixture comprising a synthetic resin, magnesium and potassium to a size of 20 meshes;
drying the ground mixture in an oven at 80-90 C for 2 hr;
compounding the dried mixture at a high speed for 5-30 min using a compounding machine; and
performing extrusion molding,
wherein alkaline reduced water is generated by magnesium and potassium when water is placed in the molded product.

5. The colorable molded product of claim 4, wherein the colorable molded product is selected from among a cup, a bathtub, a food storage container, a flowerpot, and a water jug.
